(19) United States
(12) Patent Application Publication
(10) Pub. No.: US 2026/0084677 A1
(43) Pub. Date: Mar. 26, 2026

(54) METHODS AND APPARATUS TO MONITOR ELECTRO-MECHANICAL BRAKING ACTUATOR HEALTH

(71) Applicant: Ford Global Technologies, LLC, Dearborn, MI (US)

(72) Inventors: Anuj Pal, Saint Paul, MN (US); Ritik Singh, Mooresville, NC (US); Satheesh Kumar Chandran, Livonia, MI (US); Victoria Svidenko, Newcastle, WA (US)

(21) Appl. No.: 18/891,594

(22) Filed: Sep. 20, 2024

(51) Int. Cl. B60T 17/22; B60T 13/74

(52) U.S. Cl. CPC B60T 17/221; B60T 13/745

(57) ABSTRACT

Disclosed examples include measuring, via a sensor, a brake torque generated by a brake of a braking system; providing a first current to a motor to actuate the brake, the first current to cause the measured brake torque to satisfy a target brake torque; determining a residual value based on the first current and a second current of the motor associated with a first gap between a friction material and a braking surface of the brake; detecting a condition of the braking system based on the residual value and a difference between the second current and a third current of the motor, the third current associated with a second gap between the friction material and the braking surface; and outputting an indication representative of the detected condition.

### FIELD OF THE DISCLOSURE

This disclosure relates generally to vehicles and, more particularly, to methods and apparatus to monitor electro-mechanical braking actuator health.

### BACKGROUND

Some vehicles include a brake-by-wire system. Unlike hydraulic brakes, the electric brakes of brake-by-wire systems slow the rotation of wheels of vehicles via electric actuators. Some electric brake systems (EBS) are configured such that, when the driver activates the brakes (e.g., via a brake pedal, etc.), an electrical command is sent to the actuators of the brakes, thereby causing a braking force to be applied to the wheels.

### SUMMARY

An example apparatus comprises machine-readable instructions, and at least one processor circuit to be programmed by the machine-readable instructions to measure, via a sensor, a brake torque generated by a brake of a braking system, provide a first current to a motor to actuate the brake, the first current to cause the measured brake torque to satisfy a target brake torque, determine a residual value based on the first current and a second current of the motor associated with a first gap between a friction material and a braking surface of the brake, detect a condition of the braking system based on the residual value and a difference between the second current and a third current of the motor, the third current associated with a second gap between the friction material and the braking surface, and output an indication representative of the detected condition.

At least one example non-transitory machine-readable medium comprises machine-readable instructions to cause at least one processor circuit to at least measure, via a sensor, a brake torque generated by a brake of a braking system, provide a first current to a motor to actuate the brake, the first current to cause the measured brake torque to satisfy a target brake torque, determine a residual value based on the first current and a second current of the motor associated with a first gap between a friction material and a braking surface of the brake, detect a condition of the braking system based on the residual value and a difference between the second current and a third current of the motor, the third current associated with a second gap between the friction material and the braking surface, and output an indication representative of the detected condition.

An example method comprises measuring, via a sensor, a brake torque generated by a brake of a braking system, providing a first current to a motor to actuate the brake, the first current to cause the measured brake torque to satisfy a target brake torque, determining, by at least one processor circuit programmed by at least one instruction, a residual value based on the first current and a second current of the motor associated with a first gap between a friction material and a braking surface of the brake, detecting, by one or more of the at least one processor circuit, a condition of the braking system based on the residual value and a difference between the second current and a third current of the motor, the third current associated with a second gap between the friction material and the braking surface, and outputting an indication representative of the detected condition.

### BRIEF DESCRIPTION OF THE DRAWINGS

FIG. 1 is a perspective view of a vehicle in which examples disclosed herein can be implemented.

FIG. 2 is a front view of an example drum brake assembly of the vehicle of FIG. 1.

FIG. 3 is a rear view of the example drum brake assembly of FIG. 2.

FIG. 4 is an example electro-mechanical brake (EMB) actuator system of the drum brake assembly of FIGS. 2 and 3.

FIG. 5 is a block diagram of the example drum brake assembly of FIGS. 2 and 3.

FIG. 6 is an example target brake toque versus input motor current graph.

FIG. 7 is a block diagram of an example implementation of the brake controller of FIGS. 1 and 5.

FIG. 8 is a flowchart representative of example machine-readable instructions and/or example operations that may be executed, instantiated, and/or performed by example programmable circuitry to implement the brake controller of FIG. 7.

FIG. 9 is a block diagram of an example processing platform including programmable circuitry structured to execute, instantiate, and/or perform the example machine-readable instructions and/or perform the example operations of FIG. 8 to implement the brake controller of FIG. 7.

FIG. 10 is a block diagram of an example implementation of the programmable circuitry of FIG. 9.

FIG. 11 is a block diagram of another example implementation of the programmable circuitry of FIG. 9.

In general, the same reference numbers will be used throughout the drawings and accompanying written description to refer to the same or like parts. The figures are not necessarily to scale.

### DETAILED DESCRIPTION

Examples disclosed herein relate to EMB systems in a drive-by-wire approach to braking. Examples disclosed herein may be used to monitor the health of a motor (e.g., a brushless direct current (BLDC) motor) used as an actuator (e.g., a brake actuator motor) to drive brake pads in a braking system.

Examples disclosed herein may be used to perform out-of-range condition detection in motor performance to detect degradation of a brake actuator motor. In examples disclosed herein, an out-of-range condition of a brake actuator motor means that the amount of electrical current drawn by the brake actuator motor to generate a particular brake torque is greater than a maximum electrical current value (e.g., a threshold electrical current value) that the brake actuator motor is expected to draw. A brake-by-wire system uses a closed loop control in which a requested “Brake Torque_target” (e.g., relative to a pressing force on a brake pedal) is input into the brake-by-wire closed loop. The closed loop generates an electrical current input (i_in) to the brake actuator motor based on the “Brake Torque_target” and uses the electrical current input (i_in) to cause a spread unit or a caliper to create a braking torque between brake pads and a braking surface (e.g., a brake drum, a brake rotor, etc.).

Examples disclosed herein use two target trendlines of brake torque versus motor current. A maximum at-rest gap target trendline reflects the amount of electrical current input (i_in) to the brake actuator motor that is used to generate a particular target brake torque by the spread unit when an at-rest shoe-to-drum gap is at a maximum distance. In examples disclosed herein, “at-rest” refers to a positional state of friction material on a brake shoe or brake pad during which the brake shoe or brake pad is not being driven toward the a braking surface (e.g., a brake drum or brake rotor) regardless of whether the vehicle is moving. A minimum at-rest gap target trendline reflects the amount of electrical current input (i_in) to the brake actuator motor that is used to generate a particular target brake torque by the spread unit when the at-rest shoe-to-drum gap is at a minimum distance. The two trendlines are plotted on the same graph so that min-to-max gap electrical current differences (Amax) between electrical current inputs of the two trendlines can be determined for different target brake torques.

For a particular target brake torque, examples disclosed herein determine an electrical current residual (rᵢ) for motor current as a difference between an actual motor current of the brake actuator motor (i_{act_motor}) and an expected motor current obtained from the minimum-gap trendline (i_{min_curve_motor}) (e.g., rᵢ=i_{act_motor}−i_{min_curve_motor}). Examples disclosed herein compare the electrical current residual (rᵢ) to a sum of a min-to-max gap electrical current difference (Δmax) and an experimental electrical current tolerance deviation (Δs) for a particular target brake torque. When the electrical current residual (rᵢ) is less than or equal to this sum (e.g., rᵢ≤Δₘₐₓ+Δₛ), an in-range condition (e.g., normal operation) of the brake actuator motor is detected. However, a detected out-of-range condition is flagged when the electrical current residual (rᵢ) is greater than this sum (e.g., rᵢ>Δₘₐₓ+Δₛ). If the flag remains active for a threshold number of braking cycles, examples disclosed herein activate a maintenance due notification or alert. As used herein, a braking cycle is a braking event initiated by a request to generate a target brake torque. For example, a vehicle operator pressing a brake pedal initiates a braking cycle which ends when the operator releases or stops pressing the brake pedal. A braking cycle or braking event may include multiple iterations of a feedback control loop to achieve a requested target brake torque by controlling an amount of actual brake torque applied by brake shoes.

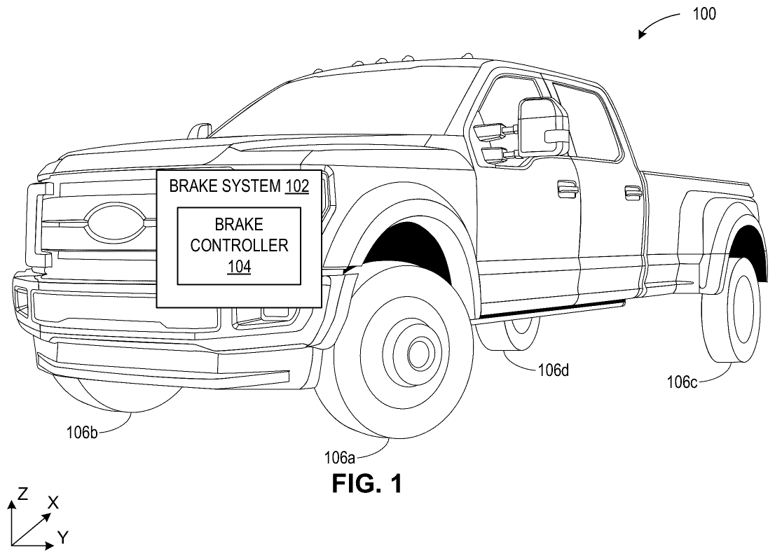

FIG. 1 is a perspective view of an example vehicle 100 in which examples disclosed herein can be implemented. In the illustrated example of FIG. 1, the vehicle 100 includes an example brake system 102, an example brake controller 104, an example first wheel 106a, an example second wheel 106b, an example third wheel 106c, and an example fourth wheel 106d.

The vehicle 100 is a motorized wheel-driven vehicle. In the illustrated example of FIG. 1, the vehicle 100 is a pick-up truck. In other examples, the vehicle 100 can be any type of vehicle with brakes (e.g., a sedan, a coupe, a van, a pick-up truck, a sports utility vehicle, an all-terrain vehicle (ATV), farming equipment, etc.). The vehicle 100 may be a fully electric vehicle, a hybrid vehicle including an internal combustion engine and electrical drive components, or an internal combustion engine (e.g., a non-electrified vehicle, a partially electrified vehicle, etc.).

In the illustrated example of FIG. 1, the brake system 102 is implemented as an EMB system that uses a brake-by-wire system. The brake system 102 includes mechanical and electrical components that slow down the rotation of the wheels 106a, 106b, 106c, 106d. The brake system 102 can receive user input (e.g., via a brake pedal, a parking brake lever/switch/pedal, etc.) or machine input (e.g., an automated command of a vehicle automation system, etc.) and cause activation of one or more brake(s) of the brake system 102.

The wheels 106a, 106b, 106c, 106d include a wheel rim and a corresponding tire. While in the illustrated example of FIG. 1, the vehicle 100 has two axles and four wheels, in other examples, the vehicle 100 can have any number of axles and wheels. In the illustrated example of FIG. 1, the first wheel 106a and the second wheel 106b are front wheels and the third wheel 106c and the fourth wheel 106d are rear wheels. In the illustrated example of FIG. 1, the first wheel 106a and the third wheel 106c are driver-side wheels and the second wheel 106b and the fourth wheel 106d are passenger-side wheels.

During the operation of the vehicle 100, the brake system 102 is controlled via the brake controller 104. For example, in response to a user input (e.g., the depression of a brake pedal, etc.) and/or a machine input (e.g., an automated command of a vehicle automation system, etc.), the brake controller 104 can cause the brake system 102 to slow down the rotation of some or all of the wheels 106a, 106b, 106c, 106d, thereby slowing the vehicle 100.

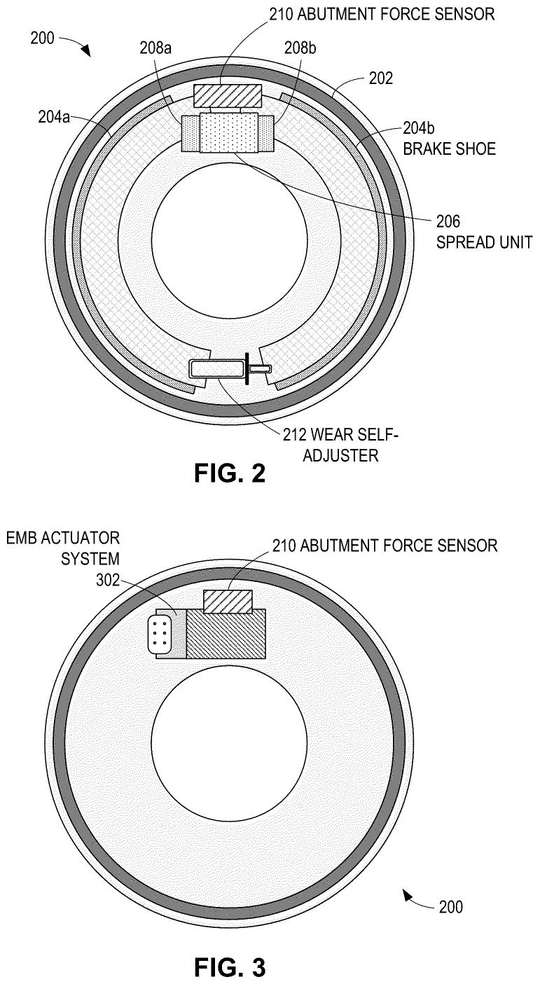

FIG. 2 is a front view of an example drum brake assembly 200 that may be used to implement the brake system 102 of the vehicle 100 of FIG. 1. The drum brake assembly 200 corresponds to one of the wheels 106a-d of the vehicle 100. Although examples disclosed herein are described relative to the drum brake assembly 200, examples disclosed herein may additionally or alternatively be used in connection with disc brake assemblies. In some examples, each of the wheels 106a-d includes a drum brake assembly substantially similar or identical to the drum brake assembly 200. In other examples, only some of the wheels 106a-d include drum brake assemblies and others of the wheels 106a-d include disc brake assemblies. For example, the rear wheels 106c,d may include drum brake assemblies and the front wheels 106a,b may include disc brake assemblies. In such brake configurations, examples disclosed herein may be implemented for the drum brake assemblies and the disc brake assemblies. In yet other examples, all of the wheels 106a-d include disc brake assemblies and examples disclosed herein may be implemented for the disc brake assemblies.

The drum brake assembly 200 includes a drum 202 that rotates in unison with a corresponding wheel (e.g., one of the wheels 106a-d). As such, rotational acceleration and speed of the drum 202 matches the rotational acceleration and speed of the corresponding wheel. Therefore, a deceleration force applied against an inner surface (e.g., a braking surface) of the drum 202 translates to commensurate deceleration of the wheel. Similarly, in a disc brake assembly, a disc brake rotor operates substantially similar to the drum 202 in that it rotates in unison with a corresponding wheel (e.g., one of the wheels 106a-d) such that rotational acceleration and speed of the rotor matches the rotational acceleration and speed of the corresponding wheel. As such, a deceleration force applied against a disc surface (e.g., a braking surface) of the disc brake rotor translates to commensurate deceleration of the wheel. The inner surface of the drum 202 in the drum brake assembly 200 and a disc surface of a disc brake rotor in a disc brake assembly can be generally referred to as braking surfaces.

The drum brake assembly 200 includes example opposing brake shoes identified as a first brake shoe 204a and a second brake shoe 204b. The brake shoes 204a,b have respective friction material surfaces that create deceleration forces when the friction material surfaces engage the inner surface of the drum 202 based on an applied brake torque. In a disc brake assembly, opposing brake pads in a brake caliper assembly also have respective friction material surfaces. Deceleration forces are created when the brake caliper assembly squeezes the brake pads together so that their friction material surfaces engage opposing disc surfaces of a disc brake rotor based on an applied brake torque.

The drum brake assembly 200 also includes an example spread unit 206. The spread unit 206 is mechanically coupled to the opposing brake shoes 204a,b. The spread unit 206 includes two opposing pistons 208a,b. In operation, the spread unit 206 is activated to push the pistons 208a,b away from one another in opposite directions. As such, the pistons 208a,b push the brake shoes 204a,b (FIG. 2) away from one another to engage the inner surface of the drum 202. When the spread unit 206 pushes the brake shoes 204a,b toward the inner surface of the drum 202, the friction material surfaces of the brake shoes 204a,b engage the inner surface of the drum 202 to generate an applied brake torque between the brake shoes 204a,b and the drum 202 (e.g., an actual brake torque between the friction material surfaces of the brake shoes 204a,b and the braking surface of the drum 202). This action slows the rotation of a corresponding one of the wheels 106a-d through frictional forces.

In a disc brake assembly, a brake caliper includes one or more brake caliper pistons that push one brake pad towards an opposing brake pad to engage opposing disc surfaces of a disc brake rotor. The brake caliper and the brake caliper piston(s) operate in a disc brake assembly to create an applied brake torque between opposing brake pads and the disc brake rotor. As such, applied brake torque can be generated by the spread unit 206 in the drum brake assembly 200 and generated by a brake caliper in a disc brake assembly. The pistons 208a,b of the spread unit 206 in the drum brake assembly 200 and brake caliber pistons of a brake caliper in a disc brake assembly can be generally referred to as brake pistons.

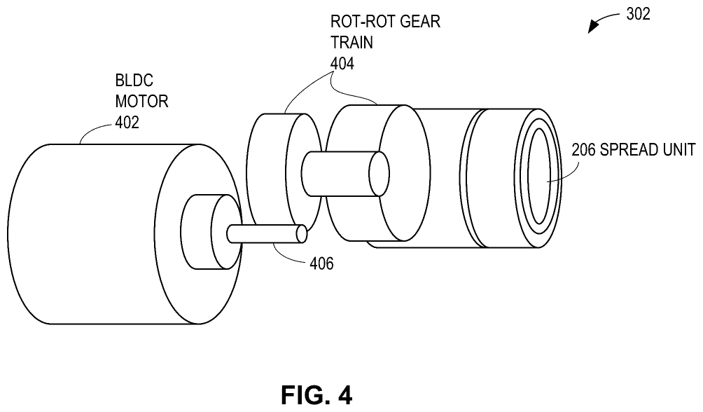

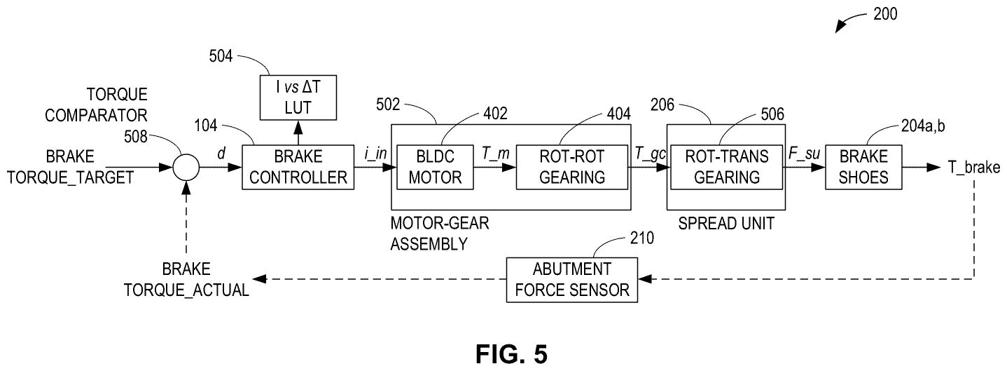

The drum brake assembly 200 includes an example abutment force sensor 210. The abutment force sensor 210 measures the amount of torque that is actually applied by the brake shoes 204a,b against the drum 202. For example, the spread unit 206 can be actuated based on an applied or requested target brake torque (e.g., through the pressing of a brake pedal, through an automated command of a vehicle automation system, etc.). However, the actual torque applied by the brake shoes 204a,b against the drum 202 may be different from the requested target brake torque. Such difference may be due to wearing of a brake actuator motor (e.g., the BLDC motor 402 of FIGS. 4 and 5). As the brake actuator motor wear increases over time, the amount of input current needed by the brake actuator motor to generate a requested target brake torque at the brake shoes 204a,b also increases. Therefore, the actual brake torque is measured by the abutment force sensor 210 and used in a feedback control loop to more accurately control the amount of actual brake torque applied by the brake shoes 204a,b based on a requested target brake torque.

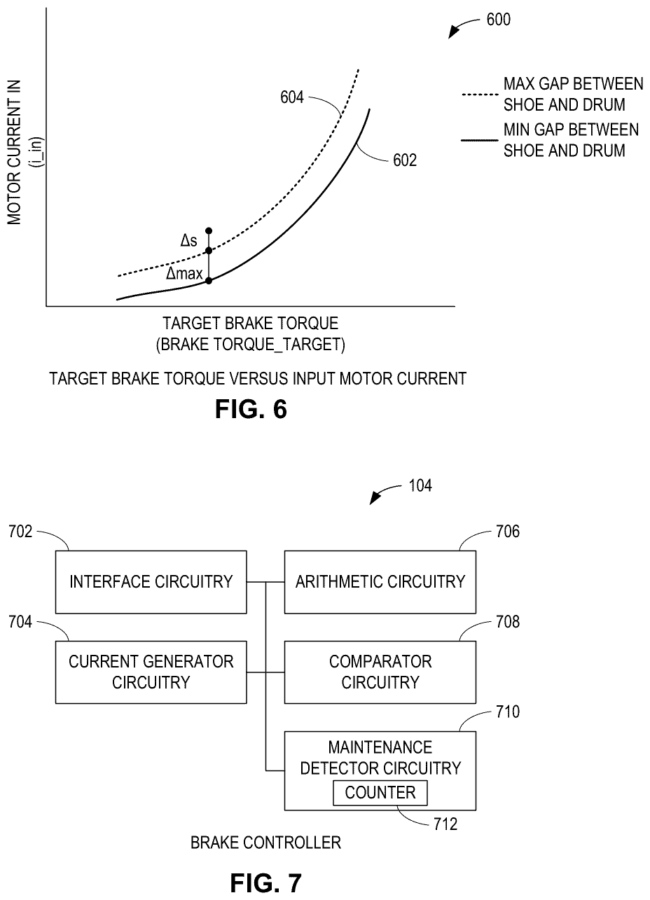

The drum brake assembly 200 includes an example wear self-adjuster 212. The wear self-adjuster 212 compensates for wearing of friction material on the brake shoes 204a,b over time. As such friction material wear increases throughout the life of the brake shoes 204a,b, an at-rest gap between the brake shoes 204a,b and the inner surface of the drum 202 also increases. The wear self-adjuster 212 mitigates for some of the friction material wear by urging the brake shoes 204a,b closer to the drum 202 as the friction material wear increases. However, differences in at-rest gaps between the brake shoes 204a,b and the inner surface of the drum 202 can still arise relative to a new condition (e.g., little or no friction material wear) of the brake shoes 204a,b and a worn condition (e.g., noticeable friction material wear) of the brake shoes 204a,b. Such differences in at-rest gaps are described below in connection with a minimum at-rest gap trendline (e.g., the minimum at-rest gap trendline 602 of FIG. 6) and a maximum at-rest gap trendline (e.g., the maximum at-rest gap trendline 604 of FIG. 6).

FIG. 3 is a rear view of the example drum brake assembly 200 of FIG. 2. In example FIG. 3, the drum brake assembly 200 includes an example EMB actuator system 302 mounted thereto. In addition, the abutment force sensor 210 is engaged with the EMB actuator system 302 (e.g., an EMB actuation chain). The EMB actuator system 302 is communicatively coupled to the brake controller 104 of FIG. 1. In operation, the brake controller 104 sends brake actuation signals (e.g., electrical current input (i_in)) to the EMB actuator system 302, and the EMB actuator system 302 generates actual braking torques between the brake shoes 204a,b and the drum 202. Measurement feedback signals of the actual braking torques are provided by the abutment force sensor 210 to the brake controller 104. The brake controller 104 uses the applied braking torque measurement feedback signals to provide corrective brake actuation signals (e.g., electrical current input (i_in)) to the EMB actuator system 302. This feedback and corrective process is performed repeatedly while a target braking torque is requested by a vehicle operator or a vehicle automation system so that a target brake torque can be achieved at the drum brake assembly 200 by the EMB actuator system 302.

FIG. 4 is the example EMB actuator system 302 of FIG. 3. The EMB actuator system 302 includes an example BLDC motor 402 operatively coupled to the spread unit 206 of FIG. 2 via an example rotational-rotational gear train 404. The BLDC motor 402 includes an example shaft 406 extending therefrom. The shaft 406 of the BLDC motor 402 provides rotational force to drive the pistons 208a,b (FIG. 2) of the spread unit 206 away from one another to increase brake torque during a braking event or closer to one another to reduce brake torque or to end the braking event.

The BLDC motor 402 operates as the actuator for braking and is controlled by the brake controller 104 of FIGS. 1 and 2. For example, in response to a target brake torque request from a vehicle operator or a vehicle automation system, the brake controller 104 sends a brake actuation signal (e.g., electrical current input (i_in)) to the EMB actuator system 302. In response, the EMB actuator system 302 causes rotation of the shaft 406 of the BLDC motor 402. The spread unit 206 receives the rotational motion from the rotational-rotational gear train 404 and converts the rotational motion to linear motion. The linear motion drives the pistons 208a,b of the spread unit 206 to push the brake shoes 204a,b into engagement with the inner surface of the drum 202. In this manner, the EMB actuator system 302 produces a desired brake torque (e.g., a target brake torque) against the drum 202 to slow the wheels 106a-d of the vehicle 100 of FIG. 1.

FIG. 5 is a block diagram of an example implementation of the example drum brake assembly 200 of FIGS. 2 and 3 to monitor the health of the BLDC motor 402 in the EMB actuator system 302. The motor health monitoring involves out-of-range condition detection in motor performance. Such motor health monitoring can be implemented during braking operation to detect degradation in performance of the BLDC motor 402. The block diagram of FIG. 5 represents a closed loop control system in which a target brake torque (Brake Torque_target) is provided for a braking event and the actual applied brake torque (T_brake) is measured (Brake Torque_actual) to iteratively control the amount of applied brake torque until the applied brake torque matches the input target brake torque.

In the illustrated example of FIG. 5, the brake controller 104 of FIG. 1 is communicatively coupled to an example motor-gear assembly 502, the motor-gear assembly 502 is coupled to the spread unit 206, and the spread unit 206 is coupled to the brake shoes 204a,b. In the example of FIG. 5, the motor-gear assembly 502 includes the BLDC motor 402 and the rotational-rotational gear train 404.

In operation, the brake controller 104 receives a target brake torque value (Brake Torque_target) based on, for example, the pressing of a brake pedal, an automated command of a vehicle automation system, etc. In example FIG. 5, the drum brake assembly 200 includes an example electrical current (I) versus torque change (ΔT) look-up-table (LUT) 504. To drive the BLDC motor 402 based on the target brake torque value (Brake Torque_target), the brake controller 104 accesses the I versus ΔT LUT 504 to retrieve an electrical current value corresponding to a change in torque amount to generate the target brake torque value. That is, the retrieved electrical current value is intended to drive the BLDC motor 402 to cause the spread unit 206 to produce an applied brake torque (T_brake) substantially equal to the target brake torque value (Brake Torque_target). To do so, the brake controller 104 generates an electrical current input (i_in) based on the electrical current value retrieved from the I versus ΔT LUT 504 and drives the BLDC motor 402 using the generated electrical current input (i_in).

When the spread unit 206 is not actively pushing the brake shoes 204a,b, the change in torque amount (ΔT) to generate the target brake torque is equal to the target brake torque value (Brake Torque_target). However, when the spread unit 206 is actively pushing the brake shoes 204a,b, the change in torque amount (ΔT) to generate the target brake torque is equal to the amount of additional torque needed to increase a presently applied brake torque (T_brake) to satisfy the target brake torque value (Brake Torque_target).

Based on the electrical current input (i_in), the BLDC motor 402 produces a corresponding motor torque, or rotational torque force, (T_m) via its shaft 406 (FIG. 4). The shaft 406 transfers the rotational torque force (T_m) to the rotational-rotational gear train 404. The rotational-rotational gear train 404 operates as a torque multiplier to increase the rotational torque force (T_m) from the shaft 406. As such, the rotational-rotational gear train 404 generates a rotational gear chain torque (T_gc) (e.g., torque output from the rotational-rotational gear train 404) based on the rotational torque force (T_m) and transfers the rotational gear chain torque (T_gc) to the spread unit 206.

The spread unit 206 includes rotational-translational gearing 506 that converts the rotational gear chain torque (T_gc) to a translational (linear) spread unit force (F_su) (e.g., a force output from the spread unit 206). The spread unit 206 uses the translational (linear) spread unit force (F_su) to drive the opposing pistons 208a,b (FIG. 2) away from one another. In turn, the pistons 208a,b push the brake shoes 204a,b in opposite directions and into engagement with the inner surface of the drum 202 to generate a braking torque (T_brake) (e.g., an actual braking torque) between the brake shoes 204a,b and the drum 202. If the vehicle 100 is in motion, the brake shoes 204a,b rub against the drum 202 to slow rotation of the drum 202. If the vehicle 100 is at a standstill, the brake shoes 204a,b press against the drum 202 to prevent rotation of the drum 202 (e.g., in a parking brake application).

The drum brake assembly 200 includes example torque comparator circuitry 508 to compare the target brake torque (Brake Torque_target) to actual brake torque (Brake Torque_actual) measurements. For example, the abutment force sensor 210 measures the actual brake torque (T_brake) applied by the brake shoes 204a,b against the drum 202 and communicates feedback of an actual brake torque value (Brake Torque_actual) to the torque comparator circuitry 508. To ensure correct braking torque is generated, the torque comparator circuitry 508 compares the actual brake torque (Brake Torque_actual) feedback to the target brake torque (Brake Torque_target) and generates a torque difference value (d). The torque comparator circuitry 508 provides the torque difference value (d) to the brake controller 104 which uses the torque difference value (d) to adjust the electrical current input (i_in) to the BLDC motor 402 until the actual brake torque (T_brake) satisfies the target brake torque (Brake Torque_target). For example, the brake controller 104 can determine that the actual brake torque (T_brake) satisfies the target brake torque (Brake Torque_target) when the torque difference value (d) is less than or equal to a torque difference tolerance value. The torque difference tolerance value may be selected to be any suitable value (e.g., within 1%, 2%, etc.) that results in an acceptable actual brake torque (T_brake) relative to the target brake torque (Brake Torque_target). The torque comparator circuitry 508 may be implemented by hardware alone or by hardware in combination with software and/or firmware.

To perform out-of-range condition detection in motor performance of the BLDC motor 402, the brake controller 104 is programmed based on the premise that for a particular target brake torque, the BLDC motor 402 will draw a certain amount of electrical current to achieve that target. The electrical current draw will also depend on the gap between the brake shoes 204a,b and the inner surface of the drum 202. In some examples, the electrical current draw also depends on motor temperature of the BLDC motor 402. To model target brake torque versus motor current for different at-rest brake shoe-to-drum gaps, an example target brake toque versus input motor current graph 600 is shown in FIG. 6.

In the illustrated example of FIG. 6, the target brake toque versus input motor current graph 600 shows two trendlines labelled as an example minimum at-rest gap trendline 602 and an example maximum at-rest gap trendline 604. In examples disclosed herein, “at-rest” refers to a state of the brake shoes 204a,b during which the BLDC motor 402 is not generating torque to spread or push the brake shoes 204a,b toward the drum 202. The minimum at-rest gap trendline 602 represents the amounts of input electrical currents drawn by the BLDC motor 402 to achieve corresponding target brake torques when an at-rest brake shoe-to-drum gap is at a minimum (e.g., the wear self-adjuster 212 maintains a minimum gap size between the brake shoes 204a,b and the drum 202). The maximum at-rest gap trendline 604 represents the amounts of input electrical currents drawn by the BLDC motor 402 to achieve corresponding target brake torques when the at-rest brake shoe-to-drum gap is at a maximum (e.g., the wear self-adjuster maintains a maximum gap size between the brake shoes 204a,b and the drum 202). As such, the minimum at-rest gap trendline 602 corresponds to a first gap size between the brake shoes 204a,b and the drum 202 when the brake shoes 204a,b are at rest (e.g., when the brake pistons 208a,b are at rest), and the maximum at-rest gap trendline 604 corresponds to a second gap size between the brake shoes 204a,b and the drum 202 when the brake shoes 204a,b are at rest (e.g., when the brake pistons 208a,b are at rest). The second gap size is bigger than the first gap size. For example, as noted above, the first gap size may correspond to the wear self-adjuster 212 maintaining a minimum gap size between the brake shoes 204a,b and the drum 202, and the second gap size may correspond to the wear self-adjuster 212 maintaining a maximum gap size between the brake shoes 204a,b and the drum 202. In some examples, the minimum at-rest gap trendline 602 corresponds to a relatively newer condition (e.g., little or no friction material wear) of the brake shoes 204a,b and the maximum at-rest gap trendline 604 corresponds to a relatively worn condition (e.g., noticeable friction material wear) of the brake shoes 204a,b.

More generally, the minimum at-rest gap trendline 602 and the maximum at-rest gap trendline 604 can apply to drum brake assemblies (e.g., the drum brake assembly 200) or disc brake assemblies. In either case, the maximum at-rest gap trendline 604 can more generally correspond to a first gap size between friction material surfaces (e.g., of the brake shoes 204a,b or brake pads) and braking surfaces (e.g., an inner surface of the drum 202 or opposing disc surfaces of a disc brake rotor) when the brake pistons 208a,b of the drum brake assembly 200 or brake piston(s) of a disc brake assembly are at rest, and the maximum at-rest gap trendline 604 corresponds to a second gap size between the friction material surfaces and the braking surfaces when the brake pistons 208a,b of the drum brake assembly 200 or brake piston(s) of a disc brake assembly are at rest.

The data for the trendlines 602, 604 can be determined through experimental or empirical processes in a laboratory, field tests, or other test environments. For example, multiple brake shoes and corresponding drums can be run through multiple braking cycles for both minimum at-rest brake shoe-to-drum gap and maximum at-rest brake shoe-to-drum gap conditions. During the braking cycles, electrical current inputs and corresponding brake torque measurements can be recorded to generate the trendlines 602, 604.

The electrical current input values (i_in) and the target brake torque values (Brake Torque_target) of the trendlines 602, 604 are stored in the I versus ΔT LUT 504. For example, the minimum at-rest gap trendline 602 is stored as minimum at-rest gap torque-to-current data in the I versus ΔT LUT 504, and the maximum at-rest gap trendline 604 is stored as maximum at-rest gap torque-to-current data in the I versus ΔT LUT 504. In this manner, the brake controller 104 can access or retrieve electrical current input values (i_in) for corresponding input target brake torque values (Brake Torque_target) during a braking event from the minimum and/or maximum at-rest gap torque-to-current data in the I versus ΔT LUT 504. The brake controller 104 can then generate corresponding input electrical currents to achieve desired braking torques (T_brake) by the brake shoes 204a,b.

During operation of the vehicle 100, the brake controller 104 can perform out-of-range condition detection based on an electrical current residual (rᵢ) for motor current determined in accordance with Equation 1 below.

$${r}_{i} = {i}_{motor}^{act} - {i}_{motor}^{min curve} \qquad ( Equation 1 )$$

In Equation 1 above,

$${i}_{motor}^{act}$$

is the actual motor current drawn by the BLDC motor 402 during operation,

$${i}_{motor}^{min curve}$$

is the target motor current obtained from the minimum at-rest gap trendline 602 of the graph 600 for a corresponding target brake torque, and rᵢ is the electrical current residual. When the target brake torque (Brake Torque_target) is satisfied, the actual motor current

$$( {i}_{motor}^{act} )$$

is the amount of electrical current drawn by the BLDC motor 402 to generate an actual brake torque (T_brake) that satisfies the target brake torque (Brake Torque_target).

The brake controller 104 compares the electrical current residual rᵢ to the sum of a min-to-max gap electrical current difference Δₘₐₓ and an electrical current tolerance deviation Δₛ (e.g., Δₘₐₓ+Δₛ). The brake controller 104 determines the min-to-max gap electrical current difference Δmax by determining the difference between the target motor current value

$${i}_{motor}^{min curve}$$

from the minimum at-rest gap trendline 602 for a target brake torque and a maximum at-rest gap motor current value from the maximum at-rest gap trendline 604 for the same target brake torque. The electrical current tolerance deviation Δₛ is an amount of experimental deviation or fluctuation that can be observed between different brake shoes and is used to account for such minor differences when the brake controller 104 is performing out-of-range condition detection in motor performance of the BLDC motor 402. The tolerance deviation Δₛ may be set to any suitable value. In some examples, the tolerance deviation Δₛ is set to zero (e.g., there is no observed deviation or fluctuation between different brake shoes). In other examples, the tolerance deviation Δₛ may be decreased or increased from an experimentally derived value to any other suitable value.

The comparison between the electrical current residual rᵢ and the sum of the min-to-max gap electrical current difference Δₘₐₓ and the electrical current tolerance deviation Δₛ(e.g., Δₘₐₓ+Δₛ) is used by the brake controller 104 to determine in-range conditions and out-of-range conditions of the BLDC motor 402. For example, the brake controller 104 uses Equation 2 below to determine whether the BLDC motor 402 is operating in an in-range condition.

$${r}_{i} \leq {Δ}_{max} + {Δ}_{s} \qquad ( Equation 2 )$$

According to Equation 2 above, if the electrical current residual rᵢ is less than or equal to the sum of the min-to-max gap electrical current difference Δₘₐₓ and the electrical current tolerance deviation Δₛ (e.g., Δₘₐₓ+Δₛ), the brake controller 104 determines that the BLDC motor 402 is operating in an in-range condition. In examples disclosed herein, an in-range condition of the BLDC motor 402 means that the amount of current (e.g., electrical current input (i_in)) drawn by the BLDC motor 402 is less than or equal to a threshold electrical current value. The threshold electrical current value may be selected to be a value that indicates the BLDC motor 402 is operating at, better than, or worse than a particular power efficiency. The brake controller 104 uses Equation 3 below to detect an out-of-range condition in the operation of the BLDC motor 402.

$${r}_{i} > {Δ}_{max} + {Δ}_{s} \qquad ( Equation 3 )$$

According to Equation 3 above, if the electrical current residual rᵢ is greater than the sum of the min-to-max gap electrical current difference Δₘₐₓ and the electrical current tolerance deviation Δₛ (e.g., Δₘₐₓ+Δₛ), the brake controller 104 detects an out-of-range condition in the operation of the BLDC motor 402 (e.g., the BLDC motor 402 is not operating in an in-range condition). In examples disclosed herein, an out-of-range condition in operation of the BLDC motor 402 means that the amount of current (e.g., electrical current input (i_in)) drawn by the BLDC motor 402 is greater than a threshold electrical current value. As noted above, the threshold electrical current value may be selected to be a value that indicates whether the BLDC motor 402 is operating at, better than, or worse than a particular power efficiency.

In some examples, the amount of actual motor current

$$( {i}_{motor}^{act} )$$

(e.g., electrical current input (i_in)) drawn by the BLDC motor 402 to produce a target brake torque (Brake Torque_target) is representative of the efficiency of the BLDC motor 402. As the BLDC motor 402 ages, its efficiency decreases which results in the BLDC motor 402 drawing higher actual motor current

$$( {i}_{motor}^{act} )$$

to produce a same target brake torque (Brake Torque_target) that it previously produced based on a lower actual motor current

$$( {i}_{motor}^{act} ) .$$

In some implementations, examples disclosed herein are selectively activated by the brake controller 104 to be performed in a vehicle after the BLDC motor 402 reaches a particular operating life. Such operating life may mark the point at which a BLDC motor is likely to show signs that warrant maintenance or replacement. In some examples, such operating life is measured by distance-in-service (e.g., miles in service, kilometers in service, etc.) or by a number of braking events (e.g., braking event count) for which the BLDC motor 402 has been used. The operating life that triggers use or activation of examples disclosed herein may be based on empirical observations of typical operating life measures of multiple BLDC motors (e.g., in field tests or laboratory environments). An example operating life of the BLDC motor 402 may be 160,000 miles or any other suitable distance. Selectively disabling examples disclosed herein in the brake controller 104 conserves processing resources which, in turn, reduces the amount of power consumed by the brake controller 104 when monitoring of the BLDC motor 402 as disclosed herein is not likely to detect a condition of the BLDC motor 402 that warrants inspection for possible maintenance or replacement.

FIG. 7 is a block diagram of an example implementation of the brake controller 104 of FIGS. 1 and 5 to perform out-of-range condition detection in the BLDC motor 402. The brake controller 104 of FIG. 7 may be instantiated (e.g., creating an instance of, bring into being for any length of time, materialize, implement, etc.) by programmable circuitry such as a Central Processor Unit (CPU) executing first instructions. Additionally or alternatively, the brake controller 104 of FIG. 7 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 7 may, thus, be instantiated at the same or different times. Some or all of the circuitry of FIG. 7 may be instantiated, for example, in one or more threads executing concurrently on hardware and/or in series on hardware. Moreover, in some examples, some or all of the circuitry of FIG. 7 may be implemented by microprocessor circuitry executing instructions and/or FPGA circuitry performing operations to implement one or more virtual machines and/or containers.

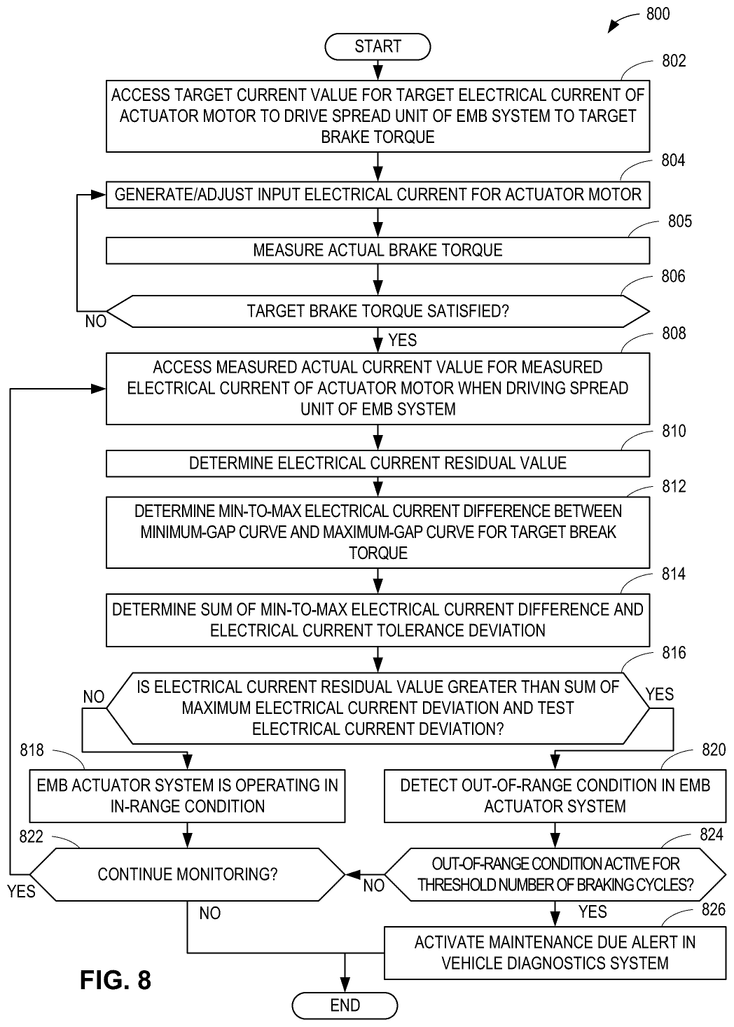

In the illustrated example of FIG. 7, the brake controller 104 includes example interface circuitry 702, example current generator circuitry 704, example arithmetic circuitry 706, example comparator circuitry 708, and example maintenance detector circuitry 710. The interface circuitry 702 is provided to receive input target brake torque values (Brake Torque_target) (e.g., through the pressing of a brake pedal, through an automated command of a vehicle automation system, etc.), access the I versus ΔT LUT 504 (FIG. 5), and receive actual brake torque values (Brake Torque_actual) from the abutment force sensor 210 (FIGS. 2 and 5). In some examples, the interface circuitry 702 is instantiated by programmable circuitry executing interface instructions and/or configured to perform operations such as those represented by the flowchart of FIG. 8.

The current generator circuitry 704 is provided to generate electrical current inputs (i_in) for the BLDC motor 402 based on electrical current values obtained from the I versus ΔT LUT 504 for corresponding input target brake torque values (Brake Torque_target). In some examples, the current generator circuitry 704 is instantiated by programmable circuitry executing current generator instructions and/or configured to perform operations such as those represented by the flowchart of FIG. 8.

The arithmetic circuitry 706 is provided to perform arithmetic operations such as determining electrical current residual values (rᵢ) in accordance with Equation 1 above and determining a sum of a min-to-max gap electrical current difference Δₘₐₓ and an electrical current tolerance deviation Δₛ (e.g., Δₘₐₓ+Δₛ). In some examples, the arithmetic circuitry 706 is instantiated by programmable circuitry executing arithmetic instructions and/or configured to perform operations such as those represented by the flowchart of FIG. 8.

The comparator circuitry 708 is provided to perform comparisons between data values. For example, the comparator circuitry 708 compares electrical current residual values (rᵢ) with the sum of a min-to-max gap electrical current difference Δₘₐₓ and an electrical current tolerance deviation Δₛ (e.g., Δₘₐₓ+Δₛ) in accordance with Equation 2 and/or Equation 3 above to detect in-range conditions and/or out-of-range conditions of the BLDC motor 402. In some examples, the comparator circuitry 708 is instantiated by programmable circuitry executing comparator instructions and/or configured to perform operations such as those represented by the flowchart of FIG. 8.

The maintenance detector circuitry 710 is provided to detect when maintenance is due in the EMB actuator system 302 (FIGS. 3 and 4). For example, the maintenance detector circuitry 710 may include an example counter 712 that increments at each braking cycle during which an out-of-range condition in motor performance of the BLDC motor 402 is detected based on a comparison by the comparator circuitry 708. The comparator circuitry 708 can compare the value of the counter 712 to a threshold number of braking cycles. The threshold number of braking cycles represents the number of braking cycles for which the out-of-range condition must be active to activate a maintenance due alert for the EMB actuator system 302. The threshold number of braking cycles may be programmed into the brake controller 104 to be any suitable value that notifies a driver or technician to maintenance due in a braking system without generating a false-positive notification. When the counter 712 exceeds the threshold number of braking cycles, the maintenance detector circuitry 710 activates a maintenance due notification or alert for the EMB actuator system 302 in a vehicle diagnostics system. The maintenance due alert may be used to represent that maintenance on a brake actuator motor (e.g., the BLDC motor 402) is due. In some examples, the maintenance detector circuitry 710 is instantiated by programmable circuitry executing maintenance detector instructions and/or configured to perform operations such as those represented by the flowchart of FIG. 8.

As described above, the torque comparator circuitry 508 of FIG. 5 and the interface circuitry 702, the current generator circuitry 704, the arithmetic circuitry 706, the comparator circuitry 708, and the maintenance detector circuitry 710 of FIG. 7 are structures. Such structures may implement means for performing corresponding disclosed functions. Examples of such functions are described above in connection with corresponding ones of the torque comparator circuitry 508, the interface circuitry 702, the current generator circuitry 704, the arithmetic circuitry 706, the comparator circuitry 708, and the maintenance detector circuitry 710 and are described below in connection with the flowchart of FIG. 8.

While an example manner of implementing the brake controller 104 of FIG. 1 is illustrated in FIG. 7, one or more of the elements, processes, and/or devices illustrated in FIG. 7 may be combined, divided, re-arranged, omitted, eliminated, and/or implemented in any other way. Further, the torque comparator circuitry 508 of FIG. 5 and the interface circuitry 702, the current generator circuitry 704, the arithmetic circuitry 706, the comparator circuitry 708, and the maintenance detector circuitry 710, and/or, more generally, the brake controller 104 of FIG. 7, may be implemented by hardware alone or by hardware in combination with software and/or firmware. Thus, for example, any of the torque comparator circuitry 508 of FIG. 5 and the interface circuitry 702, the current generator circuitry 704, the arithmetic circuitry 706, the comparator circuitry 708, and the maintenance detector circuitry 710, and/or, more generally, the brake controller 104, could be implemented by programmable circuitry in combination with machine-readable instructions (e.g., firmware or software), processor circuitry, analog circuit(s), digital circuit(s), logic circuit(s), programmable processor(s), programmable microcontroller(s), digital signal processor(s) (DSP(s)), ASIC(s), programmable logic device(s) (PLD(s)), and/or field programmable logic device(s) (FPLD(s)) such as FPGAs. Further still, the example brake controller 104 of FIG. 7 may include one or more elements, processes, and/or devices in addition to, or instead of, those illustrated in FIG. 7, and/or may include more than one of any or all of the illustrated elements, processes and devices.

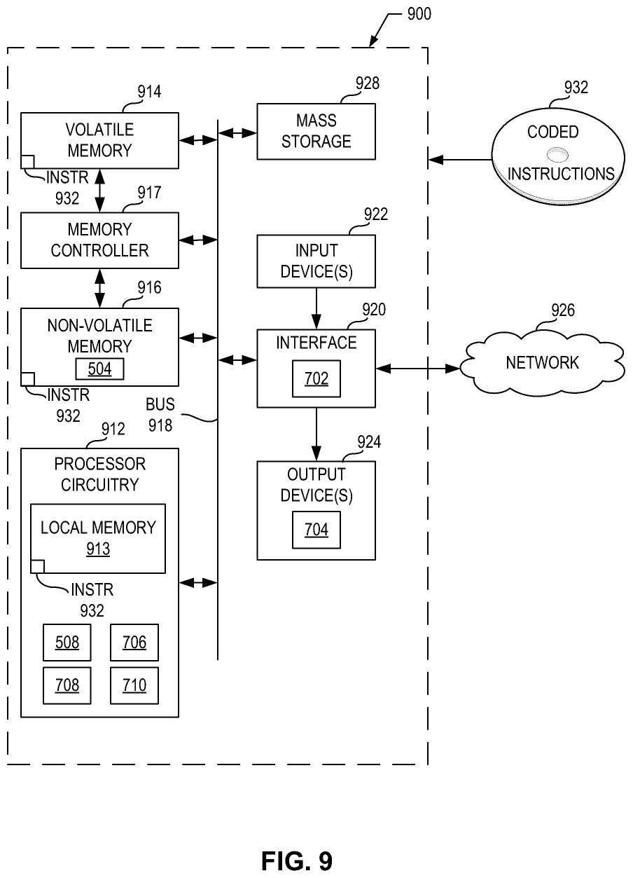

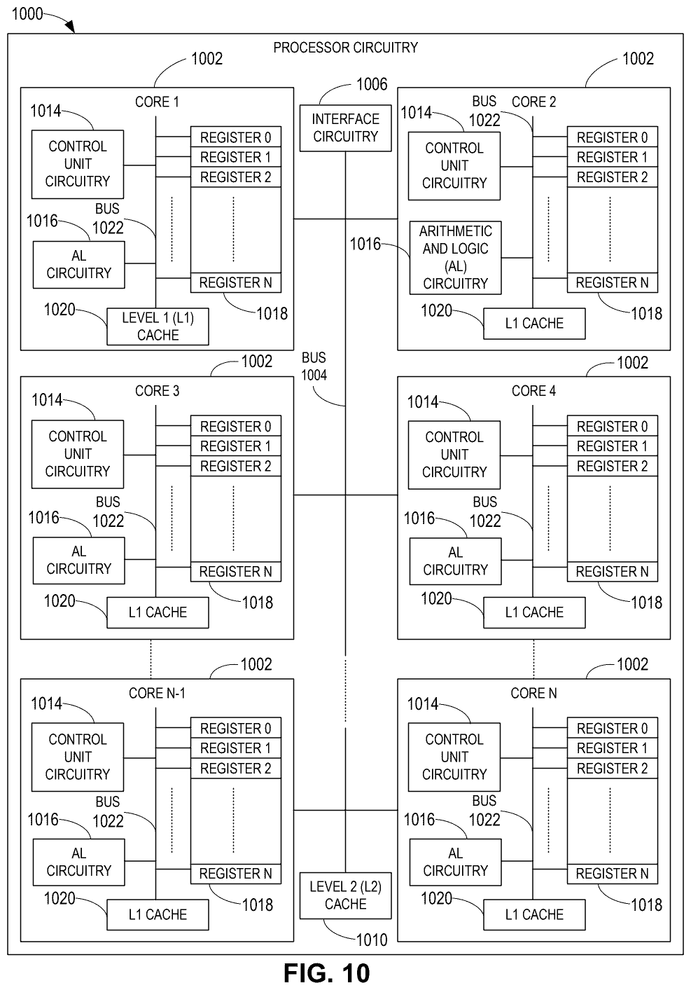

A flowchart representative of example machine-readable instructions, which may be executed by programmable circuitry to implement and/or instantiate the brake controller 104 of FIG. 7 and/or representative of example operations which may be performed by programmable circuitry to implement and/or instantiate the brake controller 104 of FIG. 7, is shown in FIG. 8. The machine-readable instructions may be one or more executable programs or portion(s) of one or more executable programs for execution by programmable circuitry such as the programmable circuitry 912 shown in the example programmable circuitry platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart illustrated in FIG. 8, many other methods of implementing the example brake controller 104 may alternatively be used. For example, the order of execution of the blocks of the flowchart may be changed, and/or some of the blocks described may be changed, eliminated, or combined. Additionally or alternatively, any or all of the blocks of the flowchart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 8 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 8 is a flowchart representative of example machine-readable instructions and/or example operations 800 that may be executed, instantiated, and/or performed by programmable circuitry (e.g., the programmable circuitry 912 of FIG. 9) to implement the brake controller 104 (FIGS. 1, 5, and 7) to perform out-of-range condition detection in motor performance of brake actuator motors (e.g., the BLDC motor 402 of FIGS. 4 and 5) to detect motor degradation. The machine-readable instructions and/or operations 800 can be performed for one of the wheels 106a-d (FIG. 1) at which the EMB actuator system 302 is located. Substantially similar or identical instructions and/or operations may be performed for others of the wheels 106a-d having their respective EMB actuator systems. The example machine-readable instructions and/or the example operations 800 of FIG. 8 begin at block 802, at which the interface circuitry 702 (FIG. 7) accesses a target current value representative of a target electrical current input to the BLDC motor 402 (e.g., an actuator motor) to drive the spread unit 206 of the EMB actuator system 302 to a target brake torque (Brake Target_torque). For example, the interface circuitry 702 accesses the target current value in the I versus ΔT LUT 504 based on an input target brake torque (Brake Torque_target) (e.g., received from the pressing of a brake pedal, from an automated command of a vehicle automation system, etc.). The brake controller 104 uses the retrieved target current value to attempt to generate an actual brake torque (T_brake) between the brake shoes 204a,b and the drum 202 that satisfies or matches the input target brake torque (Brake Target_torque). In the illustrated example, the interface circuitry 702 references the input target brake torque value in the minimum at-rest gap trendline 602 (FIG. 6) for a minimum at-rest gap between the brake shoes 204a,b and the drum 202 of the EMB actuator system 302.

The current generator circuitry 704 (FIG. 7) generates an electrical current input (i_in) for the BLDC motor 402 (e.g., an actuator motor) (block 804). The BLDC motor 402 can use the electrical current input (i_in) to generate a motor torque (T_m) to drive the spread unit 206. The abutment force sensor 210 (FIGS. 2 and 5) measures the actual brake torque (T_brake) generated by the spread unit 206 between the brake shoes 204a,b and the drum 202 (block 805).

The torque comparator circuitry 508 (FIG. 5) determines whether the input target brake torque (Target Brake_torque) is satisfied (block 806). For example, the torque comparator circuitry 508 receives a feedback measurement (e.g., an actual brake torque value (Brake Torque_actual)) from the abutment force sensor 210 of the actual brake torque (T_brake) generated by the spread unit 206 between the brake shoes 204a,b and the drum 202 (e.g., based on the measurement at block 805). The torque comparator circuitry 508 compares the actual brake torque (T_brake) to the input target brake torque (Brake Torque_target) to determine whether the actual brake torque (T_brake) satisfies the input target brake torque (Brake Torque_target) (e.g., within a 1%, 2%, etc. tolerance threshold or any other suitable tolerance threshold).

If the torque comparator circuitry 508 determines that the actual brake torque (T_brake) does not satisfy the input target brake torque (Brake Torque_target) (block 806: NO), control returns to block 804 at which the current generator circuitry 704 adjusts (e.g., increases) the electrical current input (i_in) for the BLDC motor 402 (e.g., an actuator motor) to increase the actual brake torque (T_brake) generated by the spread unit 206. As such, the abutment force sensor 210, the torque comparator circuitry 508, and the current generator circuitry 704 implement a braking torque control loop until the actual brake torque (T_brake) generated by the spread unit 206 satisfies the input target brake torque (Brake Torque_target). When the current generator circuitry 704 adjusts the electrical current input (i_in) to achieve the target brake torque (Brake Torque_target), the electrical current input (i_in) is no longer equal to the initial target current value obtained at block 802. As such, the final electrical current input (i_in) used to achieve the target brake torque (Brake Torque_target) is obtained below at block 808.

When the torque comparator circuitry 508 determines that the actual brake torque (T_brake) satisfies the input target brake torque (Brake Torque_target) (block 806: YES), control advances to block 808. At block 808, the interface circuitry 702 accesses a measured actual current value representative of the electrical current input (i_in) to the BLDC motor 402 (e.g., an actuator motor). The measured actual electrical current corresponds to the amount of electrical current drawn by the BLDC motor 402 (e.g., an actuator motor) to drive the spread unit 206 to generate the actual brake torque (T_brake) between the brake shoes 204a,b and the drum 202 that satisfies the input target brake torque (Brake Torque_target).

At block 810, the arithmetic circuitry 706 (FIG. 7) determines an electrical current residual value (rᵢ) by subtracting the measured actual current value from the target current value. For example, the arithmetic circuitry 706 uses Equation 1 above to determine the electrical current residual value (rᵢ) for electrical currents of the BLDC motor 402 based on the measured actual current value obtained at block 808 and the target current value obtained at block 802 from the I versus ΔT LUT 504.

At block 812, the arithmetic circuitry 706 determines a min-to-max gap electrical current difference Δₘₐₓ between the target current value corresponding to the minimum at-rest gap trendline 602 and a second electrical current value corresponding to the maximum at-rest gap trendline 604 for the input target brake torque (Brake Torque_target). The target current value corresponding to the minimum at-rest gap trendline 602 is an electrical current input drawn by the BLDC motor 402 to drive the brake shoes 204a,b to generate the target brake torque value (Brake Torque_target) when there is a minimum at-rest gap between the brake shoes 204a,b and the drum 202. The second electrical current value represents a second electrical current input drawn by the BLDC motor 402 to drive the brake shoes 204a,b to generate the target brake torque value (Brake Torque_target) for a maximum at-rest gap between the brake shoes 204a,b and the drum 202.

At block 814, the arithmetic circuitry 706 determines a sum of the min-to-max gap electrical current difference Δₘₐₓ and the electrical current tolerance deviation ΔS (e.g., Δₘₐₓ+Δₛ). At block 816, the comparator circuitry 708 (FIG. 7) determines whether the electrical current residual value (rᵢ) is greater than the sum of the min-to-max gap electrical current difference Δₘₐₓ and the electrical current tolerance deviation Δₛ (e.g., Δₘₐₓ+Δₛ). For example, the comparator circuitry 708 compares the electrical current residual value (rᵢ) to the sum of the min-to-max gap electrical current difference Δₘₐₓ and the electrical current tolerance deviation Δₛ(e.g., Δₘₐₓ+Δₛ) to determine whether the electrical current residual value (rᵢ) is greater than the sum of the min-to-max gap electrical current difference Δₘₐₓ and the electrical current tolerance deviation Δₛ (e.g., Δₘₐₓ+Δₛ) in accordance with Equation 3 above, or whether the electrical current residual value (rᵢ) is less than or equal to the sum of the min-to-max gap electrical current difference Δₘₐₓ and the electrical current tolerance deviation Δₛ (e.g., Δₘₐₓ+Δₛ) in accordance with Equation 2 above.

If the comparator circuitry 708 determines that the electrical current residual value (rᵢ) is not greater than the sum of the min-to-max gap electrical current difference Δₘₐₓ and the electrical current tolerance deviation Δₛ (e.g., Δₘₐₓ+Δₛ) (block 816: NO), control advances to block 818. At block 818, the comparator circuitry 708 determines that the BLDC motor 402 (e.g., the actuator motor) in the EMB actuator system 302 is operating in an in-range condition.

If the comparator circuitry 708 determines that the electrical current residual value (rᵢ) is greater than the sum of the min-to-max gap electrical current difference Δₘₐₓ and the electrical current tolerance deviation Δₛ (e.g., Δₘₐₓ+Δₛ) (block 816: YES), the comparator circuitry 708 detects an out-of-range condition in the performance of the BLDC motor 402 (e.g., the actuator motor) in the EMB actuator system 302 (block 820). The maintenance detector circuitry 710 determines whether the out-of-range condition has been active for a threshold number of braking cycles (block 824). For example, the comparator circuitry 708 can increment a value of the counter 712 (FIG. 7) at each braking cycle during which the out-of-range condition is detected at block 820 and compare the counter value to the threshold number of braking cycles.

If the maintenance detector circuitry 710 determines that the out-of-range condition has been active for the threshold number of braking cycles (block 824: YES), the maintenance detector circuitry 710 activates a maintenance due alert or notification in the vehicle diagnostics system (block 826). For example, the maintenance detector circuitry 710 can activate the maintenance due alert to output a message or other indication representative of the detected condition. The example instructions or operations 800 of FIG. 8 then end.

Otherwise, if the maintenance detector circuitry 710 determines that the out-of-range condition has not been active for the threshold number of braking cycles (block 824: NO), control advances to block 822. At block 822, the maintenance detector circuitry 710 determines whether to continue monitoring. For example, the maintenance detector circuitry 710 may determine to cease monitoring after a maintenance due alert is activated, after a braking event has ended, or after the vehicle 100 has been turned off. If the maintenance detector circuitry 710 determines to continue monitoring (block 822: YES), control returns to block 808. Otherwise, if the maintenance detector circuitry 710 determines to not continue monitoring (block 822: NO), the example instructions and/or operations 800 of FIG. 8 end.

FIG. 9 is a block diagram of an example programmable circuitry platform 900 structured to execute and/or instantiate the example machine-readable instructions and/or the example operations of FIG. 8 to implement the brake controller 104 of FIG. 7. The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, DSPs, and/or microcontrollers from any desired family or manufacturer. The programmable circuitry 912 may be implemented by one or more semiconductor based (e.g., silicon based) devices. In this example, the programmable circuitry 912 implements the torque comparator circuitry 508 of FIG. 5 and the arithmetic circuitry 706, the comparator circuitry 708, and the maintenance detector circuitry 710 of FIG. 7.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916. In the illustrated example, the I versus ΔT LUT 504 is stored in the non-volatile memory 916. Additionally or alternatively, the I versus ΔT LUT 504 may be stored in the volatile memory 914.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In some examples, the interface circuitry 920 is in communication with an example network 926. In the illustrated example, the interface circuitry 920 implements the interface circuitry 702 of FIG. 7.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, a brake pedal, a brake lever, a button, an in-vehicle graphical user interface, a vehicle automation system application programming interface (API), etc.

One or more output devices 924 are also connected to the interface circuitry 920 of the illustrated example. In the illustrate example, the output device(s) 924 implement the current generator circuitry 704 to generate and provide electrical current inputs (i_in) to the BLDC motor 402.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.) and/or solid-state storage discs or devices such as flash memory devices and/or SSDs. In some examples, the I versus ΔT LUT 504 is stored the mass storage device 928 in addition to or instead of the volatile memory 914 and/or the non-volatile memory 916.

The machine-readable instructions 932, which may be implemented by the machine-readable instructions of FIG. 8, may be stored in the mass storage device 928, in the volatile memory 914, in the non-volatile memory 916, and/or on at least one non-transitory computer-readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowchart of FIG. 8 to effectively instantiate the circuitry of FIG. 7 as logic circuits to perform operations corresponding to those machine-readable instructions. In some such examples, the circuitry of FIG. 7 is instantiated by the hardware circuits of the microprocessor 1000 in combination with the machine-readable instructions. For example, the microprocessor 1000 may be implemented by multi-core hardware circuitry such as a CPU, a DSP, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine-readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine-readable instructions and/or operations represented by the flowchart of FIG. 8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), general-purpose register(s), flag register(s), segment register(s), machine-specific register(s), instruction pointer register(s), control register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

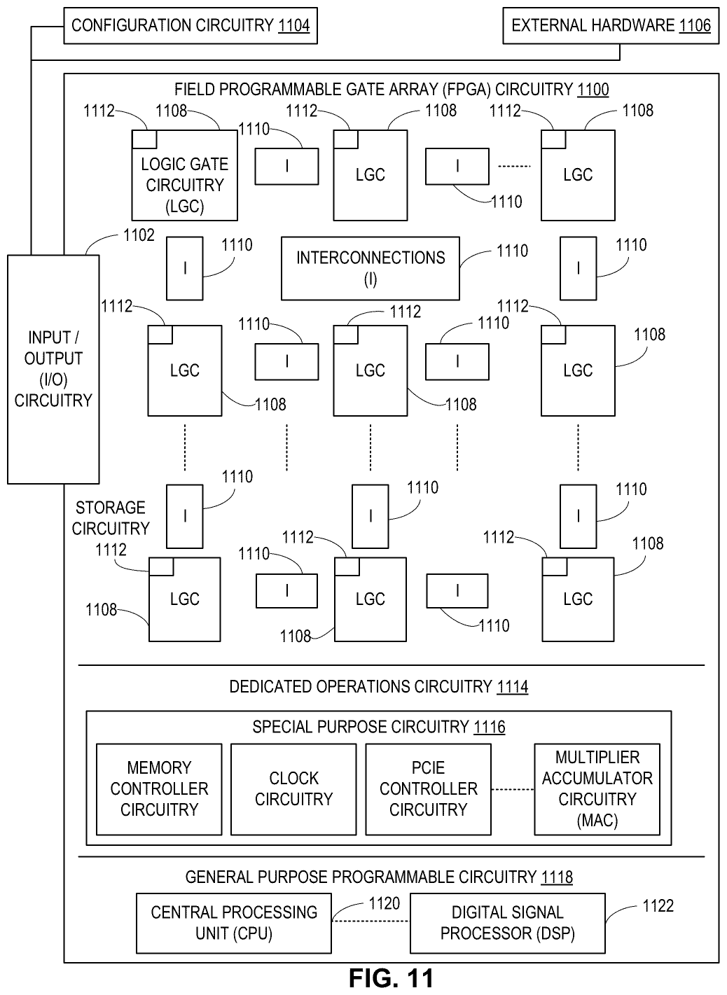

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine-readable instructions. However, once configured, the FPGA circuitry 1100 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine-readable instructions represented by the flowchart of FIG. 8 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine-readable instructions represented by the flowchart of FIG. 8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 8. As such, the FPGA circuitry 1100 may be configured and/or structured to effectively instantiate some or all of the operations/functions corresponding to the machine-readable instructions of the flowchart of FIG. 8 as dedicated logic circuits to perform the operations/functions corresponding to those software instructions in a dedicated manner analogous to an ASIC. Therefore, the FPGA circuitry 1100 may perform the operations/functions corresponding to some or all of the machine-readable instructions of FIG. 8 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine-readable instructions of FIG. 8 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions so that those functions do not need to be programmed in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 10. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine-readable instructions represented by the flowchart of FIG. 8 to perform first operation(s)/function(s), the FPGA circuitry 1100 of FIG. 11 may be configured and/or structured to perform second operation(s)/function(s) corresponding to a second portion of the machine-readable instructions represented by the flowchart of FIG. 8, and/or an ASIC may be configured and/or structured to perform third operation(s)/function(s) corresponding to a third portion of the machine-readable instructions represented by the flowchart of FIG. 8.

It should be understood that some or all of the circuitry of FIG. 7 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 7 may be instantiated, for example, in one or more threads executing concurrently and/or in series. For example, the microprocessor 1000 of FIG. 10 may execute machine-readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 7 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Digital Signal Processors (DSPs) that may execute first instructions to perform one or more operations and/or functions, one or more microcontrollers that may execute first instructions to perform one or more operations and/or functions and/or integrated circuits such as Application Specific Integrated Circuits (ASICs).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to monitor electro-mechanical braking actuator health are disclosed herein. Further examples and combinations thereof include the following:

Example 1 includes an apparatus comprising machine-readable instructions, and at least one processor circuit to be programmed by the machine-readable instructions to measure, via a sensor, a brake torque generated by a brake of a braking system, provide a first current to a motor to actuate the brake, the first current to cause the measured brake torque to satisfy a target brake torque, determine a residual value based on the first current and a second current of the motor associated with a first gap between a friction material and a braking surface of the brake, detect a condition of the braking system based on the residual value and a difference between the second current and a third current of the motor, the third current associated with a second gap between the friction material and the braking surface, and output an indication representative of the detected condition.

Example 2 includes the apparatus of example 1, wherein one or more of the at least one processor circuit is to output the indication after the condition is active for a threshold number of braking cycles, the condition is an out-of-range condition of the motor.

Example 3 includes the apparatus of example 1 and/or example 2, wherein one or more of the at least one processor circuit is to access the second current from minimum at-rest gap torque-to-current data, the minimum at-rest gap torque-to-current data representative of amounts of first electrical currents drawn by the motor to generate corresponding target brake torques for the first gap between the friction material and the braking surface.

Example 4 includes the apparatus of any one or more of examples 1-3, wherein one or more of the at least one processor circuit is to access the third current from maximum at-rest gap torque-to-current data, the maximum at-rest gap torque-to-current data representative of amounts of electrical currents drawn by the motor to generate corresponding ones of the target brake torques for the second gap between the friction material and the braking surface.

Example 5 includes the apparatus of any one or more of examples 1-4, wherein the second current is drawn by the motor to drive a brake piston from the first gap between the friction material and the braking surface, and the third current is drawn by the motor to drive the brake piston from the second gap between the friction material and the braking surface.

Example 6 includes the apparatus of any one or more of examples 1-5, wherein one or more of the at least one processor circuit is to access the first current after a braking torque control loop is used to cause a brake piston to generate the measured brake torque that satisfies the target brake torque.

Example 7 includes the apparatus of any one or more of examples 1-6, wherein the first gap is a minimum at-rest gap size between the friction material and the braking surface when a brake piston is at rest, the second gap is a maximum at-rest gap size between the friction material and the braking surface when the brake piston is at rest, the second gap bigger than the first gap.

Example 8 includes the apparatus of any one or more of examples 1-7, wherein one or more of the at least one processor circuit is to determine the residual value by subtracting the first current from the second current, and detect the condition based on the residual value being greater than the difference between the second current and the third current.

Example 9 includes at least one non-transitory machine-readable medium comprising machine-readable instructions to cause at least one processor circuit to at least measure, via a sensor, a brake torque generated by a brake of a braking system, provide a first current to a motor to actuate the brake, the first current to cause the measured brake torque to satisfy a target brake torque, determine a residual value based on the first current and a second current of the motor associated with a first gap between a friction material and a braking surface of the brake, detect a condition of the braking system based on the residual value and a difference between the second current and a third current of the motor, the third current associated with a second gap between the friction material and the braking surface, and output an indication representative of the detected condition.

Example 10 includes the at least one non-transitory machine-readable medium of example 9, wherein the machine-readable instructions are to cause one or more of the at least one processor circuit to output the indication after the condition is active for a threshold number of braking cycles, the condition is an out-of-range condition of the motor.

Example 11 includes the at least one non-transitory machine-readable medium of example 9 and/or example 10, wherein the machine-readable instructions are to cause one or more of the at least one processor circuit to determine the residual value by subtracting the first current from the second current, and detect the condition based on the residual value being greater than the difference between the second current and the third current.

Example 12 includes the at least one non-transitory machine-readable medium of any one or more of examples 9-11, wherein the first gap is a minimum at-rest gap size between the friction material and the braking surface when a brake piston is at rest, the second gap is a maximum at-rest gap size between the friction material and the braking surface when the brake piston is at rest, the second gap bigger than the first gap.

Example 13 includes the at least one non-transitory machine-readable medium of any one or more of examples 9-12, wherein the machine-readable instructions are to cause one or more of the at least one processor circuit to access the first current after a braking torque control loop is used to cause a brake piston to generate the measured brake torque that satisfies the target brake torque.

Example 14 includes a method comprising measuring, via a sensor, a brake torque generated by a brake of a braking system, providing a first current to a motor to actuate the brake, the first current to cause the measured brake torque to satisfy a target brake torque, determining, by at least one processor circuit programmed by at least one instruction, a residual value based on the first current and a second current of the motor associated with a first gap between a friction material and a braking surface of the brake, detecting, by one or more of the at least one processor circuit, a condition of the braking system based on the residual value and a difference between the second current and a third current of the motor, the third current associated with a second gap between the friction material and the braking surface, and outputting an indication representative of the detected condition.

Example 15 includes the method of example 14, wherein the outputting of the indication is after the condition is active for a threshold number of braking cycles, the condition is an out-of-range condition of the motor.

Example 16 includes the method of example 14 and/or example 15, wherein the second is accessed from minimum at-rest gap torque-to-current data, the minimum at-rest gap torque-to-current data representative of amounts of first electrical currents drawn by the motor to generate corresponding target brake torques for the first gap between the friction material and the braking surface.

Example 17 includes the method of any one or more of examples 14-16, further including accessing the third current from maximum at-rest gap torque-to-current data, the maximum at-rest gap torque-to-current data representative of amounts of electrical currents drawn by the motor to generate corresponding ones of the target brake torques for the second gap between the friction material and the braking surface.

Example 18 includes the method of any one or more of examples 14-17, wherein the second current is drawn by the motor to drive a brake piston from the first gap between the friction material and the braking surface, and the third current is drawn by the motor to drive the brake piston from the second gap between the friction material and the braking surface.

Example 19 includes the method of any one or more of examples 14-18, wherein the first current is accessed after a braking torque control loop is used to cause a brake piston to generate the measured brake torque that satisfies the target brake torque.

Example 20 includes the method of any one or more of examples 14-19, wherein the first gap is a minimum at-rest gap size between the friction material and the braking surface when a brake piston is at rest, the second gap is a maximum at-rest gap size between the friction material and the braking surface when the brake piston is at rest, the second gap bigger than the first gap.

From the foregoing, it will be appreciated that example systems, apparatus, articles of manufacture, and methods have been disclosed that monitor electro-mechanical braking actuator health. Disclosed systems, apparatus, articles of manufacture, and methods monitor the health degradation of a motor used as an actuator (e.g., a brake actuator motor) to operate brake shoes or brake pads in a vehicle braking system. Disclosed systems, apparatus, articles of manufacture, and methods are accordingly directed to operations of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
machine-readable instructions; and
at least one processor circuit to be programmed by the machine-readable instructions to:
measure, via a sensor, a brake torque generated by a brake of a braking system;
provide a first current to a motor to actuate the brake, the first current to cause the measured brake torque to satisfy a target brake torque;
determine a residual value based on the first current and a second current of the motor associated with a first gap between a friction material and a braking surface of the brake;
detect a condition of the braking system based on the residual value and a difference between the second current and a third current of the motor, the third current associated with a second gap between the friction material and the braking surface; and
output an indication representative of the detected condition.

2. The apparatus of claim 1, wherein one or more of the at least one processor circuit is to output the indication after the condition is active for a threshold number of braking cycles, the condition is an out-of-range condition of the motor.

3. The apparatus of claim 1, wherein one or more of the at least one processor circuit is to access the second current from minimum at-rest gap torque-to-current data, the minimum at-rest gap torque-to-current data representative of amounts of first electrical currents drawn by the motor to generate corresponding target brake torques for the first gap between the friction material and the braking surface.

4. The apparatus of claim 3, wherein one or more of the at least one processor circuit is to access the third current from maximum at-rest gap torque-to-current data, the maximum at-rest gap torque-to-current data representative of amounts of electrical currents drawn by the motor to generate corresponding ones of the target brake torques for the second gap between the friction material and the braking surface.

5. The apparatus of claim 1, wherein the second current is drawn by the motor to drive a brake piston from the first gap between the friction material and the braking surface, and the third current is drawn by the motor to drive the brake piston from the second gap between the friction material and the braking surface.

6. The apparatus of claim 1, wherein one or more of the at least one processor circuit is to access the first current after a braking torque control loop is used to cause a brake piston to generate the measured brake torque that satisfies the target brake torque.

7. The apparatus of claim 1, wherein the first gap is a minimum at-rest gap size between the friction material and the braking surface when a brake piston is at rest, the second gap is a maximum at-rest gap size between the friction material and the braking surface when the brake piston is at rest, the second gap bigger than the first gap.

8. The apparatus of claim 1, wherein one or more of the at least one processor circuit is to:
determine the residual value by subtracting the first current from the second current; and
detect the condition based on the residual value being greater than the difference between the second current and the third current.

9. At least one non-transitory machine-readable medium comprising machine-readable instructions to cause at least one processor circuit to at least:
measure, via a sensor, a brake torque generated by a brake of a braking system;
provide a first current to a motor to actuate the brake, the first current to cause the measured brake torque to satisfy a target brake torque;
determine a residual value based on the first current and a second current of the motor associated with a first gap between a friction material and a braking surface of the brake;
detect a condition of the braking system based on the residual value and a difference between the second current and a third current of the motor, the third current associated with a second gap between the friction material and the braking surface; and
output an indication representative of the detected condition.

10. The at least one non-transitory machine-readable medium of claim 9, wherein the machine-readable instructions are to cause one or more of the at least one processor circuit to output the indication after the condition is active for a threshold number of braking cycles, the condition is an out-of-range condition of the motor.

11. The at least one non-transitory machine-readable medium of claim 9, wherein the machine-readable instructions are to cause one or more of the at least one processor circuit to:
determine the residual value by subtracting the first current from the second current; and
detect the condition based on the residual value being greater than the difference between the second current and the third current.

12. The at least one non-transitory machine-readable medium of claim 9, wherein the first gap is a minimum at-rest gap size between the friction material and the braking surface when a brake piston is at rest, the second gap is a maximum at-rest gap size between the friction material and the braking surface when the brake piston is at rest, the second gap bigger than the first gap.

13. The at least one non-transitory machine-readable medium of claim 9, wherein the machine-readable instructions are to cause one or more of the at least one processor circuit to access the first current after a braking torque control loop is used to cause a brake piston to generate the measured brake torque that satisfies the target brake torque.

14. A method comprising:
measuring, via a sensor, a brake torque generated by a brake of a braking system;
providing a first current to a motor to actuate the brake, the first current to cause the measured brake torque to satisfy a target brake torque;
determining, by at least one processor circuit programmed by at least one instruction, a residual value based on the first current and a second current of the motor associated with a first gap between a friction material and a braking surface of the brake;
detecting, by one or more of the at least one processor circuit, a condition of the braking system based on the residual value and a difference between the second current and a third current of the motor, the third current associated with a second gap between the friction material and the braking surface; and
outputting an indication representative of the detected condition.

15. The method of claim 14, wherein the outputting of the indication is after the condition is active for a threshold number of braking cycles, the condition is an out-of-range condition of the motor.

16. The method of claim 14, wherein the second is accessed from minimum at-rest gap torque-to-current data, the minimum at-rest gap torque-to-current data representative of amounts of first electrical currents drawn by the motor to generate corresponding target brake torques for the first gap between the friction material and the braking surface.

17. The method of claim 16, further including accessing the third current from maximum at-rest gap torque-to-current data, the maximum at-rest gap torque-to-current data representative of amounts of electrical currents drawn by the motor to generate corresponding ones of the target brake torques for the second gap between the friction material and the braking surface.

18. The method of claim 14, wherein the second current is drawn by the motor to drive a brake piston from the first gap between the friction material and the braking surface, and the third current is drawn by the motor to drive the brake piston from the second gap between the friction material and the braking surface.

19. The method of claim 14, wherein the first current is accessed after a braking torque control loop is used to cause a brake piston to generate the measured brake torque that satisfies the target brake torque.

20. The method of claim 14, wherein the first gap is a minimum at-rest gap size between the friction material and the braking surface when a brake piston is at rest, the second gap is a maximum at-rest gap size between the friction material and the braking surface when the brake piston is at rest, the second gap bigger than the first gap.
